(19) United States
(12) Patent Application Publication
(10) Pub. No.: US 2008/0316040 A1
(43) Pub. Date: Dec. 25, 2008

(54) Secure Monitoring Terminal

(76) Inventor: Frederic Aberlenc, Eguilles (FR)

Correspondence Address: Horst M. Kasper, 13 Forest Drive, Warren, NJ, 07059, US

(21) Appl. No.: 11/658,294

(22) PCT Filed: Jul. 20, 2005
(86) PCT No.: PCT/FR2005/001876

§ 371 Date: Jan. 22, 2007

(30) Foreign Application Priority Data
Jul. 20, 2004 (FR) 0407993

(51) Int. Cl. G08B 21/00; G08B 5/22

(52) U.S. Cl. 340/670; 340/825.49; 340/540

(57) ABSTRACT

The invention relates to a monitoring terminal (TS), comprising positional information acquisition means (M1S), determination means (AGS-MGS) to provide location information in response to a received signal from a positioning system. Said terminal further comprises calculation means (MCS) to calculate the distance between said position and said location.

The present invention relates to a secure surveillance terminal.

The scope of this invention is especially that of the surveillance of persons. One thinks naturally of a hiker or mountaineer who is in distress, being either lost or injured for example. One can also think of a child who strays from its parents.

In such a situation, it is appropriate to communicate the position of the entity under surveillance, mountaineer or child, to the overseeing entity, a third party such as a parent or friend, so that the latter can initiate a search procedure.

A first known surveillance system uses a telecommunications infrastructure including a radio communications network and a wired network, interconnected together. The entity under surveillance, a child for example, is equipped with a locating terminal consisting in a mobile phone coupled to a “GPS” receiver. The term GPS (which stands for “Global Positioning System”) describes a whole array of satellites that broadcast signals enabling the receiver to obtain its space coordinates.

The overseeing entity, one of the parents for example, has in his/her possession a surveillance terminal that can take the form of a phone or a personal computer connected to the Internet network. In order to obtain the child's position, the father or mother gains access to a server using his/her surveillance terminal. The server contacts the child's locating terminal, which terminal delivers the child's position by means of the GPS receiver. The server then transmits this information to the surveillance terminal through two networks.

A second known surveillance system uses two point-to-point radio terminals, each being coupled to a GPS receiver. The entity under surveillance has in its possession a locating terminal which transmits a locating message which includes its position, when said entity has pressed a button on this terminal. The overseeing entity has a surveillance terminal intended to receive this locating message in order to acquire the position of the locating terminal.

In the United States of America, this system makes it possible to communicate via channels reserved for the so-called “Citizen Band” (an amateur radio system known as “CB”). Thus, by using channels of the “FRS” type (“Family Radio Services”) in the 460 MHz UHF band, the coverage length amounts to 3 km.

These two known systems make it possible for a surveillance terminal to indicate the absolute position of a locating terminal, in other words, its position in a fixed reference system, for example by means of its latitude, longitude and possibly altitude.

The absolute position of the entity under surveillance is of course important data for the overseeing entity although it is not sufficient in deciding on an optimised search strategy during a distress situation. Actually, should the overseeing entity immediately warn a search and rescue team or is it advisable for them to immediately start searching for the entity under surveillance? The slightest loss of time could be catastrophic in certain cases.

Therefore, the objective of the present invention is to help the overseeing entity adopt the best search strategy in the event the entity under surveillance is in distress.

In accordance with the invention, a surveillance terminal comprises:
acquisition means of position information,
determination means to generate some spot information in response to a reception signal coming from a positioning system;

This terminal also comprises means of calculating the distance between this position and this spot.

Therefore, the distance that separates the position of the locating terminal from the spot where the surveillance terminal is situated constitutes a fundamental parameter. If this distance is relatively short, it is probably more efficient for the overseeing entity to start searching for the entity under surveillance immediately, provided they have the means to rescue it. If however this distance is great, it is undoubtedly preferable to call a search and rescue team.

Preferably, this terminal generates a first warning signal if this distance exceeds a first predetermined threshold, this distance being a first measurement.

Likewise, the terminal generates a second warning signal if the travelling speed of the position exceeds a second predetermined threshold, this speed being a second measurement.

Also, the terminal generates a third warning signal if the travelling speed of the position relative to the spot exceeds a third predetermined threshold, this speed being a third measurement.

According to an further characteristic, the terminal comprises display means for at least one of these measurements.

Moreover, the surveillance terminal comprising a compass, it also comprises a servo-control module of these display means on the compass.

Advantageously, the terminal comprises indicating means of the direction for the position.

According to a preferred embodiment thereof, the terminal comprising:
reception means of the position information,
control means to link together the acquisition means and the reception means in response to an activation signal,
it also comprises a co-ordination unit to automatically generate this activation signal.

Preferably, this activation signal coincides with a predetermined time interval of a repetitive frame synchronised on a clock signal.

Furthermore, the terminal comprises means of positioning this predetermined time interval in the frame.

Moreover, the frame including a first subframe made up of allocated time intervals and a second subframe made up of priority time intervals, this predetermined time interval is an allocated time interval.

Advantageously, these two subframes are interleaved.

By way of example, the frame which lasts 30 seconds, contains 30 allocated time intervals of 500 ms each, and 30 priority time intervals of 500 ms each.

On the other hand, the terminal features means of identifying a free allocated time interval.

According to a first option, as the reception signal contains synchronisation information, the terminal comprises means for generating the activation signal in response to this synchronisation information.

According to a second option, the terminal additionally receiving identifying information associated with the position information, the reception means functioning uninterruptedly, it includes a memory in which an identification value is stored, the activation signal being generated by a co-ordination unit in the event of a match between this identifying information and this identification value.

Moreover, the terminal additionally receiving an alarm word associated with the position information, it comprises means to generate as well the activation signal in response to this alarm word.

Then, the terminal comprises means to generate a warning signal in response to this alarm word.

The present invention will now be described in more detail by describing some embodiments thereof, by way of example, with reference to the appended figures representing:

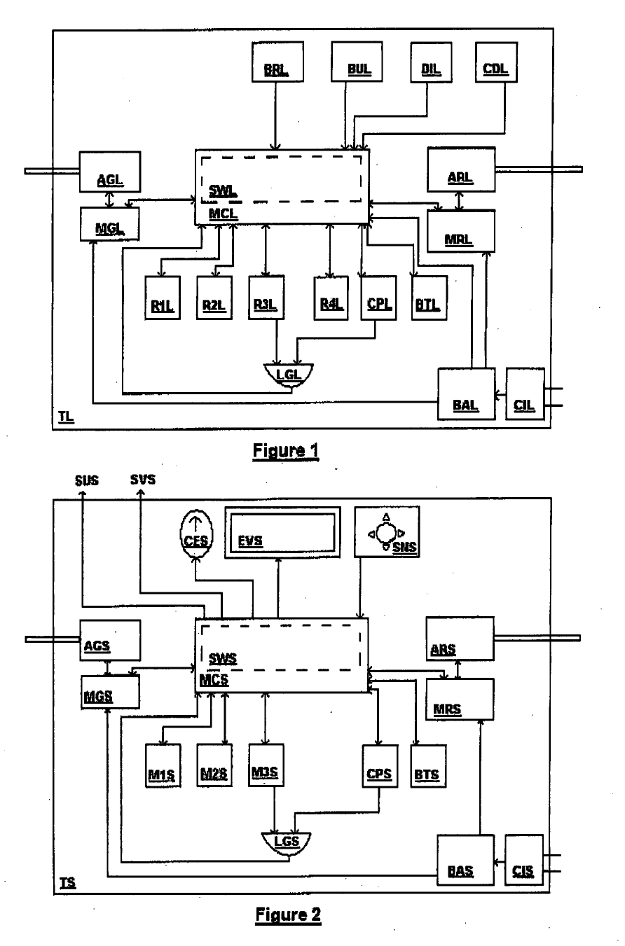

FIG. 1: a diagram of a locating terminal, and

FIG. 2: a diagram of a surveillance terminal.

As regards hertzian wave communications, the frequency spectrum is such a precious commodity that it forms the subject of strict regulations. Accordingly, this spectrum is distributed between numerous applications such as radio broadcasting, television broadcasting, amateur radio systems, point-to-point communications between two terminals (walkie-talkies for example), wireless phone communications, mobile phones, links via satellite for communication systems, radio guidance, and remote controls for a wide range of appliances, not to mention military applications. All of these applications are subjected to a regulatory authorisation.

By way of example, in the United States of America, the FRS system encompasses 14 channels in the 460 MHz UHF band. This type of short distance direct communication makes it possible to do without “heavy” networks of the GSM type.

In addition to the preceding applications, it can frequently happen that at least one narrow band channel be made available for free usage providing that certain conditions be met, such as:
maximum transmission power,
maximum pass band width,
usage time quota.

As an example, in France, we can freely use the channel called “Band 869-500 mW” with a central frequency of 869 MHz. In actual facts, this channel extends from 869.40 MHz to 869.65 MHz.

Although the invention applies directly to all known surveillance systems, it yields a further advantage in that it offers to implement a time multiplexing of this channel, used at a data rate of 1,200 bits/second.

In such a surveillance system using a multiplexed channel, a frame is thus defined, in which the messages transferred between terminals are inserted.

To put it simply, a frame is subdivided into a plurality of time intervals which each correspond to a subchannel. Each subchannel is capable of supporting unidirectional communication between two terminals. In order to be able to identify the subchannel allocated to them, these terminals must have a common time reference or, in other words, they must be synchronised on the frame.

Several known techniques make it possible to synchronism a terminal to the other. They won't be described in any more detail as they belong to the state-of-the-art.

Another technique consists in separately synchronising the two terminals to a time signal which constitutes a common reference. One may think in the first place of the GPS system which delivers a universal time whose precision is of the order of the nanosecond. This precision is remarkable and it is obviously quite sufficient for implementing this invention.

According to a preferred embodiment thereof, the frame comprises several subframes, two in this case. By convention, the first frame is made up of a group of allocated time intervals and the second subframe of a group of priority time intervals.

Practically speaking, the frame lasts 30 seconds and comprises 60 time intervals of 500 milliseconds. The two subframes each comprise 30 time intervals. The first subframe is comprised of the time intervals having an uneven digit place within the frame, and the second subframe is comprised of those having an even digit place within this frame. It thus appears that these two subframes are interleaved, this arrangement being substantiated below.

With reference to FIG. 1, a locating terminal TL is designed so as to obtain its geographical position in one way or another, that is to say its space, or at the very least planar, co-ordinates. In this case, the “GPS” positioning system is made use of, and the terminal therefore includes spotting means in the form of a “GPS” antenna AGL coupled to a “GPS” receiver MGL.

These spotting means AGL, MOL are linked to a control unit such as a microcontroller MCL featuring its application software SWL. Data to the acquisition means, a RAM memory which, in this case, can be reduced to a first R1L register, are populated by the MCL microcontroller that provides them with a locating message. This message comprises essentially some position information relating to the terminal TL position, that corresponds to its coordinates in any reference system, such as its latitude, its longitude and possibly its altitude.

This first register R1L is used to transmit the locating message. Further details about this transmission operation are provided below.

Optionally, this locating message comprises some identifying information relating to the identification of the locating terminal TL, which is stored for example in a “ROM”-type memory (which stands for “Read-Only Memory”), a second register R2L in this case.

Considering the transmission data rate of 1,200 bits per second and the duration of a time interval, which lasts 500 ms, the maximum capacity of the first register R1L is then equal to the product of these two values, that is to say 600 bits. In practice, a safety margin of 40 bits is kept, so that a 660-bit register is considered, whose content is commonly called a transmission burst.

Typically, this data burst comprises:
possibly a header section,
possibly a synchronisation word,
imperatively a body,
possibly an end section.

This synchronisation word can be required when the two terminals exchanging this data burst are not synchronised in terms of the frequency or of the time to a common external reference.

The data burst body comprises the useful information, that which forms the subject of the transmission, and it accordingly contains the locating message.

The locating terminal TL also comprises communication means. Here these are transmission means tuned to the 869 MHz channel, that combine a radio transmitter MRL and a transmission antenna ARL. The transmitter is also linked to the microcontroller MCL.

It also comprises control means which can be integrated within the microcontroller MCL, to connect the acquisition means R1L to the radio transmitter MRL in response to an activation signal generated by a co-ordination unit which might also be integrated within the microcontroller. Thus, this activation signal triggers off the transmission burst.

It also comprises a counter CPL with a capacity that is equal to the number of time intervals in the frame, in this case 60. This counter is incremented by a clock signal coming from a time base BTL which issues a beep whenever the time interval changes, every 500 milliseconds in this case. It then indicates the sequence number within the frame for the current time interval.

The time base BTL is here synchronised to the GPS receiver MGL. It is also possible to provide a periodic resetting to zero of the counter CPL in order to prevent a possible drift of this counter.

The locating terminal TL also features a third register R3L that is used to synchronise the burst transmission. This register R3L is advantageously a memory of the EEPROM type (which stands for “Electrically Erasable PROgrammable Memory”). It identifies the sequence number within the frame for the time interval allocated to the terminal. The activation signal is generated by the co-ordination unit between the current value of the counter CPL and the value stored in the third register R3L. In this case, a logic gate LGL is used, which provides the logical AND function for these two values.

The third register R3L is initialised with an initialisation value that is permanently stored in the terminal TL. This value can even be inscribed on the casing of this terminal so that it can easily be accessible. The contents of this register can possibly be modified using a setting knob BRL whose operating mode is described below.

The various elements of the locating terminal TL are electrically supplied from a battery BAL, possibly connected to an internal charger CIL.

In this way, the locating message transmission is triggered off periodically within the same time interval of the successive frames, automatically without requiring any user action.

Moreover, simultaneously, the locating terminal TL is designed so as to manage emergency situations.

A first alarm signal originates from an immersion detector DIL and is produced for the intention of the microcontroller MCL. This detector is activated whenever the terminal TL is immersed, after falling in a swimming pool or accidentally falling over the railing on a ship, for example.

A second alarm signal originates from an emergency button BUL also connected to the microcontroller MCL. This button can be actuated by the user of the terminal TL under different circumstances:
actual or potential attack,
faintness fit, malaise,
panic,
incapacity to find one's way.

A third alarm signal originates from a shock detector CDL such as an accelerometer which also generates it for the intention of the microcontroller MCL. In this way an abnormal situation can be identified, no matter whether the terminal has fallen of its own or if it has been made to fall because the person carrying it has fallen.

Following the generation of any alarm signal whatsoever, the microcontroller MCL introduces an alarm word such as “SOS” In the locating message and the identification of the terminal TL (stored in the second register).

This alarm word can be substituted to the position information in the locating message, or a well identified place can be reserved to it within this message.

Moreover, it is also advisable to specify the nature of the situation which brought about the generation of this alarm signal. So, in the event of an occurrence of the first, second or third alarm signal, the alarm word comprises the respective information: “WATER”, “FIT” or “SHOCK”.

The locating terminal TL features a fourth register R4L initialised for a value which does not identify a priority time interval. Advantageously, this register is also an “EEPROM” (“Electrically Erasable PROgrammable Memory”) which, upon the occurrence of any alarm signal, is charged by the sum modulo 60 of the double of the integer fraction of the half of the current value of counter CPL plus an offset value equal to 2n, where n is just any positive integer. It is then no longer modified until it is reset, and such resetting can take place in particular due to the occurrence of the activation signal, or to a time delay. The fourth register R4L thus identifies a priority time interval in the second subframe, namely the nth that follows the current time interval.

The microcontroller MCL is also programmed so as to generate the activation signal in the event of a match between the current value of the counter CPL and the value stored in the fourth register R4L.

This allows for rapid transmission of the alarm word, within the next priority time interval if n equals 1. It is not necessary to wait for the next allocated time interval of the terminal TL which can come about at the latest 30 seconds after the occurrence of an alarm signal. The reason why these two subframes are interleaved is now clearly demonstrated.

Moreover it is preferable to repeat the alarm word within one or several priority time intervals following that during which its first transmission took place.

It should also be noted that, if the microcontroller MCL does not modify the locating message, this alarm word will also be repeated within the next allocated time interval of terminal TL.

The arrangement of the subframes that has been applied until now leaves a significant place to priority time intervals. In order to increase the number of locating terminals that can simultaneously use this channel of 869 MHz, it is possible to reduce the size of the second subframe, by specifying for example that it comprises time intervals whose digit place within the frame is a multiple of 4.

With reference to FIG. 2, a surveillance terminal TS also comprises communication means. Here, these are reception means, combining a radio receiver MRS and a reception antenna ARS tuned to a channel of 869 MHz. The receiver MRS is also linked to a control unit such as a microcontroller MCS featuring its own application software SWS.

It also comprises acquisition means, that come here as a first reception memory M1S, which is of the RAM type.

It further comprises control means that can be incorporated within the microcontroller MCS, to connect these acquisition means M1S to the radio receiver MRS in response to an activation signal.

Additionally, it comprises a counter CPS, the capacity of which equals the number of time intervals within the frame, 60 in this case. This counter is incremented by a clock signal coming from a time base BTS issuing a beep whenever the time interval changes, every 500 milliseconds in this case. So it indicates the sequence number in the frame of the current time interval.

Just as the locating terminal TL, the surveillance terminal TS receives from the GPS positioning signal, a reception signal via the determination means consisting of a GPS antenna AGS coupled to a GPS receiver MGS.

These determination means AGS, MGS are linked to the microcontroller MCS. Data to a second memory M2S of the RAM type, that can simply consist of a register, are populated by the microcontroller MCS that also provides a situation message. This message comprises for the most part some spot information in relation with the geographical situation of the surveillance terminal TS, corresponding to its coordinates in just any reference system, for example its latitude, its longitude and possibly its altitude.

The time base BTS is here synchronised to the GPS receiver MGS, it is also possible to provide a periodic resetting to zero of the counter CPS in order to prevent a possible drift of this counter.

The surveillance terminal TS also features a third memory M3S that is used to synchronise the burst reception. This third memory M3S identifies within the frame the sequence number for the time interval allocated to a locating terminal.

According to a first synchronisation method, which is of general use in state-of-the-art techniques, the activation signal is produced by a co-ordination unit in the event of a match between the current value of the counter CPS and the value stored in the third memory M3S. In this case, a logical gate LGS is used to provide the logical AND function for these two values.

This memory is initialised with the initialisation value of the third register R3L of the locating terminal TL.

However, by the time this locating terminal is put into service, it can be that this initialisation value corresponds to a time interval of the frame which is already in use.

It is therefore advisable to identify by means of the radio receiver MRS of the surveillance terminal TS, which allocated time intervals are available within the channel in order to reserve one of these, the first one for example, to display it in any possible way and to load it into the third memory M3S. Such identification can typically be carried out by measuring the level received within these time intervals.

Let us specify now that the contents of the third register R3L of the locating terminal TL can be modified by means of the setting button BRL so as to retain obviously the time interval identified in the third memory M3S of the surveillance terminal TS.

A parameter setting mode of the locating terminal TL is provided for that purpose.

By way of example, this terminal TL being provided with a light emitting diode (LED), pressing a first time the setting button BRL brings about a temporary flashing of the LED while simultaneously starting a time delay. Depressing this button again before the time delay has elapsed causes the terminal to enter the parameter setting mode. If the button is not actuated while that time delay is running, the terminal automatically enters the “normal operation” mode.

In the parameter setting mode, the content of the third register R3L is incremented by two units by pressing this button BRL.

According to a first option, a display device can be provided to that effect on the locating terminal TL to visualize the content of one's third register R3L.

According to a second option, provisions can be made for the locating terminal TL to transmit at very low power by the time it is put into service, as it is placed quite near the surveillance terminal TS. The locating terminal TL inserts an initialisation word within the locating message. It is then necessary to “play with” the setting button BRL until the surveillance terminal TS recognizes that initialisation word. A second option makes it possible to relocate the synchronisation indication for the two terminals from the locating terminal TL to the surveillance terminal TS. In this case, the display device on the locating terminal TL is no longer required.

To exit the parameter setting mode, just any type of secure handling of the setting button BRL is to be provided, such as pressing the button twice successively within a short time period, or pressing the button just once for a relatively longer time.

The various elements of the surveillance terminal TS are electrically supplied from a battery BAS, possibly connected to an internal charger CIS.

Within the surveillance terminal TS, the activation signal is also generated during all the priority time intervals of the second subframe.

According to a second synchronisation method of the surveillance terminal TS, the terminal also listens to all the allocated time intervals of the first subframe.

In this case, the third memory M3S contains an identification value which is not the time interval allocated to the locating terminal TL but the identification of this terminal TL. Of course, this terminal TL will by then have placed within this locating message the identification information stored in its second register R2L.

The activation signal is then generated by the co-ordination unit in the event of a match between the identification information and the identification value stored in the third memory M3S.

The present invention allows to choose from two synchronisation methods of the surveillance terminal TS. It would of course apply too to some other synchronisation method which is not described here.

In known surveillance systems, the acquisition of the locating message containing the position of the locating terminal is subject to some demanding conditions. On the contrary, in a multiplexed channel system such as described above, such acquisition is periodically triggered off in the same time interval of the first successive subframes and permanently during the second sub-frame, automatically without requiring any user action.

The present invention proposes to significantly improve both known surveillance systems and the multiplexed channel system to which the following references apply.

Accordingly, the control unit of the surveillance terminal (i.e. the microprocessor) MCS can make use of the position information of the locating terminal on the one hand, and the spot information supplied to it by the GPS receiver MRS, on the other hand.

It comprises means of calculating the distance between this position and this spot.

Thus, when the child is in the vicinity, it is suggested to search for it immediately before it wanders further away. If, on the other hand, the child is already far away, it would be more advisable to warn a rescue team such as the police, highway patrol, or the fire brigade.

If this distance exceeds a first predetermined threshold, the surveillance terminal TS generates a first warning signal SUS either in the form of a light, acoustic or vibratory signal.

Likewise, if the travelling speed for the position of the locating terminal TL exceeds a second predetermined threshold, the surveillance terminal TS generates a second warning signal SVS identical to the first warning signal SUS.

The child's travelling speed makes it possible to know whether it is walking slowly, if it is running or even if it is in a motor vehicle.

It can also be envisaged that the relative travelling speed of the locating terminal with respect to the surveillance terminal be subject to some monitoring. In this case, if this relative speed exceeds a third predetermined threshold, the surveillance terminal generates a third warning signal (not shown here).

The three thresholds mentioned above can be introduced in the surveillance terminal by means of any man-machine interface such as a keyboard.

In addition to that, the surveillance terminal comprises display means, for example a display screen EVS connected to the control unit MCS. If the latter can access a navigation system SNS, it is then possible to move a background map across this screen EVS so as to display by means of a dot or a cross the position of the locating terminal TL, and possibly its speed by means of a vector.

Preferably, the surveillance terminal also comprises a compass CES and a servo-control module (not shown) of the display means EVS. Thus, the map orientation is independent from the position of the terminal.

The surveillance terminal can also feature the indication of the direction in which the locating terminal is to be found. This indication can be included for example on the periphery of the screen EVS or on some other display means. It can also be in the form of an arrow superimposed upon the map background at the centre of which the surveillance terminal is situated.

Moreover, the distance between the two terminals is displayed, just as is also the North indication.

In the multiplexed channel surveillance system, if an alarm signal has been generated by the locating terminal TL, a new locating message coming from this terminal is made available in the surveillance terminal TS as soon as it has been transmitted. Indeed, its microcontroller MCS keeps listening to all the time intervals of the second subframe. This microcontroller MCS comprises means to recognize the identification of the locating terminal TL in the locating message and, based on that, to extract the alarm word so as to convey its meaning in whichever way, i.e. visual and/or audible and/or vibratory.

Whichever surveillance system is adopted, advantageously, the surveillance terminal is capable of following/monitoring several locating terminals. The means to be implemented to achieve that are readily accessible to the person skilled in the art, this having to do substantially with duplication. So this won't be described in any more detail. Let us simply specify that this terminal must have the identifications for all the locating terminals that it monitors. The information relating to these various terminals can be displayed successively or simultaneously providing that each terminal is identified by a distinctive graphic sign or by a specific colour.

The above examples of some embodiments of this invention have been chosen due to their concrete nature. It would not be possible anyhow to list exhaustively all of the embodiment methods covered by this invention. In particular, any described means can be replaced by equivalent means without departing from the scope of this invention.

1. A surveillance terminal TS comprising:
reception means MRS of a position information,
determination means AGS-MGS to produce a spot information in response to an reception signal coming from a positioning system, characterized in that it also comprises means MCS to calculate the distance between said position and said spot.

2. The terminal according to claim 1, characterised in that it produces a first warning signal SUS if said distance exceeds a first predetermined threshold, this distance being a first measurement.

3. The terminal according to claim 1, characterized in that it produces a second warning signal SVS if the traveling speed of said position exceeds a second predetermined threshold, this speed being a second measurement.

4. The terminal according to claim 1, characterised in that it produces a third warning signal if the relative traveling speed of said position with respect to said spot exceeds a third predetermined threshold, this speed being a third measurement.

5. The terminal according to claim 2, characterized in that it comprises display means EVS of et least one of said measurements.

6. The terminal according to claim 5 characterized in that, comprising a compass CES, it comprises a slaving module of said display means EVS on said compass CES.

7. The terminal according to claim 1 characterized in that it comprises indicating means EVS of the direction of said position.

8. The terminal according to claim 1, characterized in that, comprising:
reception means MRS-ARS of said position information,
control means MCS to connect said acquisition means M1S and said reception means in response to an activation signal,
it also comprises a co-ordination unit MCS to produce automatically said activation signal.

9. The terminal according to claim 8, characterized in that said activation signal coincides with a predetermined time interval of a repetitive frame synchronized an a clock signal.

10. The terminal according to claim 9, characterized in that it comprises means MRS to position said predetermined time interval in said frame.

11. The terminal according to claim 10, characterized in that, said frame 5 comprising a first subframe consisting of allocated time intervals and a second sub frame consisting of priority time intervals, said predetermined time interval is an allocated time interval.

12. The terminal according to claim 11, characterised in that said subframes are interleaved.

13. The terminal according to claim 9, characterized in that said frame lasts 30 seconds and comprises 30 allocated time intervals of 500 ms and 30 priority time intervals of 500 ms.

14. The terminal according to claim 11 characterised in that it comprises means ARS-MRS, MCS to identify a free allocated time interval.

15. The terminal according to claim 8, characterized in that, said reception signal comprising a synchronization information, it comprises means LGS, CPS, M3S to produce said activation signal in response to said synchronization information.

16. The terminal according to claim 8, characterized in that, additionally receiving an identifying information associated with said position information, said reception means ARS-MRS functioning uninterruptedly, it comprises a memory M3S in which an identification value is stored, said activation signal being produced by said co-ordination unit in the event of a match between said identifying information and said identification value.

17. The terminal according to claim 8 characterised in that, additionally receiving an alarm word associated with said position information, it comprises means MCS to also produce said activation signal in response to this alarm word.

18. The terminal according to claim 17, characterized in that it comprises means to produce a warning signal SUS-SVS in response to said alarm word.
